(19) United States
(12) Patent Application Publication
(10) Pub. No.: US 2018/0355283 A1
(43) Pub. Date: Dec. 13, 2018

(54) CLEANING COMPOSITION FOR INDUSTRIAL COATING LINE

(71) Applicant: BOSTIK SA, La Plaine Saint-Denis (FR)

(72) Inventor: David GOUBARD, Compiegnes (FR)

(73) Assignee: BOSTIK SA, La Plaine Saint-Denis (FR)

(21) Appl. No.: 16/061,031

(22) PCT Filed: Dec. 6, 2016
(86) PCT No.: PCT/FR2016/053229

§ 371 Date: Jun. 11, 2018

(30) Foreign Application Priority Data
Dec. 11, 2015 (FR) 1562235

(51) Int. Cl. C11D 3/16; C11D 3/37; C11D 3/20; C11D 11/00

(52) U.S. Cl. CPC C11D 3/162; C11D 3/3726; C11D 11/0041; C11D 3/2093; C11D 3/3749

(57) ABSTRACT

1) Cleaning composition comprising:
from 5% to 99% of a thermoplastic polymer which does not react with moisture (a),
from 1% to 15% of a monofunctional silane compound (b);
from 0% to 94% of a compound (c) chosen from a plasticizer (c1), an oil (c2) or a tackifying resin (c3);
said composition being homogeneous and having a Brookfield viscosity, measured at 100° C., within the range extending from 20 to 200 000 mPa·s.

2) Process for cleaning the walls of items of industrial equipment which are coated with a layer of composition C comprising a polymer P having alkoxysilane groups, said process comprising the mixing of said composition C with the cleaning composition according to 1).

A subject matter of the present invention is a composition suitable in particular for cleaning the walls of items of industrial equipment which are coated with a layer of a composition comprising a polymer having alkoxysilane groups, in particular a heat-crosslinkable adhesive composition. The items of industrial equipment concerned are, for example, those employed in a process for the manufacture of said adhesive composition or a process for employing the latter by coating, for the purpose of the manufacture of self-adhesive supports, in particular by means of an industrial coating line. The present invention also relates to a process for cleaning said walls which employs the composition according to the invention.

There are known, in particular by the applications PCT WO 2009/106699 and EP 2 336 208, heat-crosslinkable adhesive compositions which comprise:
a polymer comprising two hydrolyzable terminal groups of alkoxysilane type,
a tackifying resin, and
a crosslinking catalyst.

Such compositions are advantageously employed in the manufacture of a self-adhesive support which is itself used for the manufacture of labels and/or self-adhesive tapes. This is because self-adhesive supports have, at ambient temperature, an immediate adhesiveness and an immediate tackiness (also known as tack) which makes possible their instantaneous adhesion to a substrate under the effect of a light and brief pressure.

These self-adhesive supports are generally manufactured by a process which comprises the stages:
(a) of preheating such an adhesive composition to a temperature of between 50° C. and 130° C., then
(b) the coating thereof on a support layer by means of coating devices, such as a lip nozzle, then
(c) of crosslinking the support thus coated by heating at a temperature of between 50° C. and 150° C.

The term of “crosslinking” is understood to denote the chemical reaction during which the hydrolyzable groups (in particular terminal groups) of alkoxysilane type of the different polymeric chains of the polymer react with one another, under the action of atmospheric moisture, to form a bond of siloxane type, thus resulting in the growth of said chains and in the formation of a three-dimensional polymeric network. The three-dimensional polymeric network thus formed contributes, with the tackifying resin(s) included in the composition, to conferring the desired self-adhesive properties on the support and to constituting, after the fixing of said support to a substrate by means of a light and brief pressure, the adhesive seal which firmly bonds said support and substrate. The crosslinking reaction can also be carried out in part, in an undesired manner, under the action of the water present in the form of traces in the ingredients of the adhesive composition.

According to a first known embodiment of the prior art, an industrial plant suitable for the implementation of the process for the manufacture of the self-adhesive supports mentioned above first of all comprises a tank for storage of the adhesive composition which comprises the polymer with two alkoxysilane terminal groups, for example in the form of a 200-liter drum. The adhesive composition, which is generally solid or extremely viscous at ambient temperature, is heated, preferably to a temperature of 80° C. to 130° C., so as to exhibit a sufficient viscosity for it to circulate in-line. A heating means is provided for this, generally consisting of a plate which is brought into contact with the adhesive composition in the drum and which is heated electrically by resistances. Said plate (hereinafter denoted by the term of “heating plate”) is provided, on the part thereof which is in contact with the adhesive composition to be heated, either with a smooth exchange surface or, more often, with an exchange surface augmented by the presence of fins forming a certain angle with said surface.

This industrial plant also comprises a coating nozzle and a feed line which connects the heating plate to said nozzle, via a circulation pump. The feed line is itself provided with heating means suitable for maintaining the high temperature necessary for the in-line circulation of the adhesive composition. The feed line can, for example, be a flexible polytetrafluoroethylene (PTFE) hose reinforced with a wire mesh, which wire mesh is equipped with electrical resistances and which hose is thermally insulated from the external environment.

A layer of adhesive composition of controlled thickness (corresponding to a grammage, expressed in g/m², which is also controlled) is then applied by means of the coating nozzle to a support layer progressing forward on a roller in front of said nozzle, and the layer thus coated is subjected, by means of an oven or a chamber, to a controlled temperature and to a controlled degree of humidity, so as to provide for the crosslinking of the polymer having alkoxysilane end groups included in the adhesive composition.

The European patent application EP 2 878 364 describes another embodiment of an industrial plant which results from the modification of this first embodiment by the insertion, on the feed line of the coating nozzle and upstream of the latter, of an induction heating device which operates by Foucault currents induced by a magnetic field generated by an inductor cable. This heating device makes it possible for the adhesive composition to better reach the application temperature required for its fluidization at the coating nozzle, without risk of premature crosslinking at the heating plate and/or in the feed line leading to said nozzle. This heating device includes a static mixer, which consists of a tube comprising an electrically conductive material, which forms a pipe for circulation of the adhesive composition inserted into the feed line of the nozzle, and in which an assembly of mixing elements is positioned. These mixing elements exhibit surfaces for deflection of the adhesive composition in circulation, suitable for improving its homogeneity over a short distance. Apart from the static mixer, the induction heating device thus also comprises an inductor cable in the form of a solenoid positioned around the tube.

The European patent application EP 2 886 201 describes yet another embodiment of an industrial plant which results from the modification of the first embodiment by supplying the feed line of the coating nozzle from two sources. This supplying from two sources makes it possible to separate the polymer having end groups of alkoxysilane type and the crosslinking catalyst. In other words, the storage tank (typically a 200-liter drum) contains at least said polymer and a tackifying resin without the catalyst, and the latter is introduced at the feed line by a mixer which can either be a dynamic mixer or a static mixer of the type of that described above. Supplying from these two distinct sources makes it possible to limit the risk of premature crosslinking of the polymer having alkoxysilane end groups in the line which leads to the coating nozzle, at least upstream of the mixing thereof with the catalyst.

The industrial plants which have just been described can be used for processing, under continuous conditions or by manufacturing campaigns, different grades of heat-crosslinkable adhesive compositions, for the purpose of the manufacture of the different grades of corresponding self-adhesive supports. These different grades of adhesive compositions differ in the nature of the polymer(s) having alkoxysilane end groups and/or of the tackifying resin(s). When, on conclusion of a campaign for the manufacture of one of these grades, the storage tank for said composition (for example the 200-liter drum) is exhausted, it is necessary to halt the operation of the plant and to then dismantle it and clean it.

Due to its highly viscous nature, residual amounts of heat-crosslinkable adhesive composition are present and/or capable of being present on the walls of various regions of the industrial line, after it has been shut down, in particular in the “dead” regions, in other words the regions of the line in contact with which the rate of flow of the composition, during the operation of the line under continuous conditions, is weak or nonexistent. Such walls are, for example, the surface of the heating plate provided or not provided with fins, the internal walls of the flexible heating hose made of reinforced PTFE mentioned above, the internal walls of the components made of stainless steel which connect said flexible to the heating plate and to the coating nozzle and, finally, some walls located inside the coating nozzle. When a static or dynamic mixer is present in the plant, amounts of adhesive composition can also remain on the mixing elements present in the tube of said mixer.

In point of fact, shutting down the industrial plant, followed by dismantling it, has the effect of introducing air into the line. The consequence of this is that the polymer having alkoxysilane end groups which is included in these residual amounts of adhesive composition reacts, according to the crosslinking reaction, with the moisture of the ambient air to form other residual products which are for their part crosslinked. These crosslinked residual products are gels of very high viscosity which are thus virtually no longer miscible in the noncrosslinked adhesive composition. These crosslinked residual products are also capable of being formed in the event of a prolonged shutdown of the industrial plant filled with heat-crosslinkable adhesive composition, under the action of the water present in the form of traces in the ingredients of the adhesive composition.

Due precisely to their adhesiveness and their tack properties, these crosslinked residual products adhere very strongly to the internal walls of the dead regions of the line. For this reason, they lead to fouling of the plant and to blocking of some of its parts, which can interfere with or prevent any subsequent renewed start up.

The removal and the discharge of these very sticky residues is thus an operation which, at ambient temperature, is very difficult industrially.

For the same reasons, it is also very difficult to clean the industrial plants which, more generally, have been brought into contact with compositions comprising a polymer having end groups of alkoxysilane type, particularly heat-crosslinkable adhesive compositions. Mention may be made, as other example of such plants, of the mixers which are used for the manufacture of said compositions.

Manual cleaning by operators, by means of solvents such as methyl ethyl ketone or ethyl acetate, can be envisaged. However, such a solution presents serious problems of industrial health and safety for the operators and requires, due to the risks of an explosive atmosphere, suitable items of industrial equipment.

The removal of these residues by means of an abrasive agent exhibits disadvantages originating from the internal damage which may result therefrom during repeated uses and also from the presence, in the plant, of regions which are difficult to reach, which thus cannot be correctly cleaned.

The aim of the present invention is to overcome these difficulties, in all or in part.

A first subject matter of the present invention is a cleaning composition comprising, on the basis of the total weight of said composition:
from 5% to 99% by weight of a thermoplastic polymer which does not react with moisture (a) chosen from:
polyurethanes having hydroxyl or alkyl end groups, in particular the polyurethanes obtained from polyether polyols, polyester polyols and/or polyolefin polyols;
polyamides;
polyesters;
ethylene-based copolymers, in particular copolymers based on ethylene and vinyl acetate, copolymers based on ethylene and acrylate(s);
amorphous poly(α-olefine)s, often denoted by the acronym of APAO (for Amorphous Poly Alpha Olefin), polybutadiene or polyisoprene;
block polyolefins;
styrene block copolymers;
acrylic copolymers, in particular acrylic block copolymers;
polymeric alcohols obtained by oxidation of α-olefins,
from 1% to 15% by weight of a silane compound (b) comprising a single alkoxysilane group;
from 0% to 94% by weight of a compound (c) chosen from a plasticizer (c1), an oil (c2) or a tackifying resin (c3);

said composition being homogeneous and having a Brookfield viscosity, measured at 100° C., within the range extending from 20 to 200 000 mPa·s.

It is specified that the use of the indefinite article “a” or “an” to denote the ingredients (a), (b), (c), (c1), (c2) and (c3) included in the composition according to the invention should be understood in the sense of “at least one” or also of “one or more”. Thus, it is clearly understood that said competition can comprise one or more polymers (a), one or more compounds (b) and also one or more compounds (c), it being possible for the latter also to be several ingredients of identical or different type taken from (c1), (c2) or (c3).

This is because it has been found that this cleaning composition is capable of forming, at a temperature of between 50° C. and 130° C. and preferably between 80° C. and 120° C., a substantially homogeneous mixture with a heat-crosslinkable adhesive composition comprising a polymer having end groups of alkoxysilane type. Said mixture has advantageous properties of nonadherence, of viscosity and of stability over time of its viscosity. As a result of these properties, the cleaning composition according to the invention can be fed into an industrial line in which there occur, in particular on its walls, residues of a heat-crosslinkable adhesive composition, and is suitable for the discharge of said residues in the form of a viscous liquid which can circulate in the plant, in particular through the pump(s). The industrial line can thus be cleaned of the residues of said crosslinkable adhesive composition. Furthermore, it has been found that the risk of crosslinking of the polymer having alkoxysilane end groups is thus avoided, and thus the risk of formation of crosslinked residual products which adhere strongly to the walls of the line, consequently preventing the risk of blocking of the latter.

The term “thermoplastic polymer which does not react with moisture” is intended to denote any polymer or copolymer devoid of chemical functional groups liable to react (in particular by a crosslinking reaction) with atmospheric moisture to form a three-dimensional polymeric network, such as, for example, alkoxysilane and isocyanate functional groups.

The thermoplastic polymer (a) which does not react with moisture is preferably chosen from polyurethanes, polyamides, polyesters, ethylene-based copolymers, acrylic copolymers and polymeric alcohols obtained by oxidation of α-olefins.

Polymers (a) which are even more preferred are copolymers based on ethylene and vinyl acetate (denoted hereinafter by the acronym EVA) and polyurethanes having hydroxyl end groups.

Mention may be made, as example of commercially available EVA, of Evathane® 40-55, sold by Arkema. Mention may be made, as example of polyurethanes having hydroxyl end groups, of Pearlbond™ 100, which is obtained from polycaprolactone and is sold by Lubrizol.

The cleaning composition according to the invention comprises, in addition to a thermoplastic polymer which does not react with moisture (a), from 1% to 15% by weight, on the basis of the total weight of said composition, of a silane compound (b) comprising a single alkoxysilane group, said compound also being denoted by the term of “monofunctional silane”.

The silane compound (b) comprises a single alkoxysilane group, preferably of formula (I):

—Si(R¹)ₙ(OR²)₃₋ₙ (I)

in which:
R¹ and R², which are identical or different, each represent a linear or branched alkyl radical of 1 to 4 carbon atoms, optionally interrupted by an oxygen atom, with in addition the possibility, when there are several R² radicals, for the latter, which are identical or different, to form a ring;
n is an integer equal to 0, 1 or 2.

According to a preferred alternative form, the silane compound (b) is chosen from the compounds of following formulae:

R⁴—SiR¹ₙ(OR)₃₋ₙ (II)

R⁵—C(O)—O—R³—SiR¹ₙ(OR²)₃₋ₙ (III)

R⁶—C(O)—N(R⁸)—R³—SiR¹ₙ(OR²)₃₋ₙ (IV)

R⁷—O—C(O)—NH—R³—SiR¹ₙ(OR²)₃₋ₙ (V)

(R⁷)(R⁹)N—C(O)—NH—R³—SiR¹ₙ(OR²)₃₋ₙ (VI)

in which:
R¹, R² and n are as defined above;
R³ represents a divalent alkylene radical, which is preferably linear, comprising from 1 to 4 carbon atoms;
R⁴ represents a linear or branched alkyl or alkenyl radical comprising from 2 to 60 carbon atoms;
R⁵, R⁶ and R⁷ represent, each taken independently, a linear or branched alkyl or alkenyl, aromatic or alicyclic radical comprising from 1 to 60 carbon atoms;
R⁸ represents a linear or branched alkyl or alkenyl, aromatic or alicyclic radical comprising from 1 to 6 carbon atoms;
R⁹ represents a hydrogen atom, a linear or branched alkyl or alkenyl radical, an aromatic radical or an alicyclic radical comprising from 1 to 60 carbon atoms.

The compounds of formulae (II) to (VI) defined above are prepared according to known processes and many are available commercially.

Mention may thus be made, as examples of compounds (b):
of formula (II): Silquest® Y 15866 of formula:

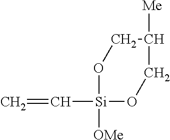

which is available from Momentive;
of formula (IV):
   Geniosil® XL 33 of formula:

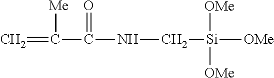

which is available from Wacker Chemie;
Silquest® A 174 of formula:

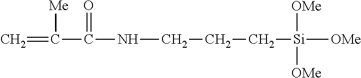 [SMILES: C=C(C)C(=O)NCCC[Si](OC)(OC)OC]

which is available from Momentive;
of formula (V):
   Geniosil® XL 63 of formula:

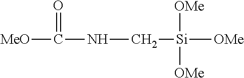 [SMILES: COC(=O)NC[Si](OC)(OC)OC]

Geniosil® XL 65 of formula:

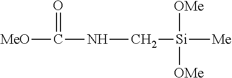 [SMILES: COC(=O)NC[Si](C)(OC)OC]

Geniosil® GF 60 of formula:

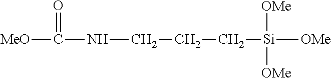 [SMILES: COC(=O)NCCC[Si](OC)(OC)OC]

these three compounds being available from Wacker Chemie.

Finally, in addition to the ingredients (a) and (b), the composition according to the invention can also comprise, optionally, up to 94% by weight of a compound (c) chosen from a plasticizer (c1), an oil (c2) or a tackifying resin (c3).

According to one embodiment of the composition according to the invention, the compound (c) is a plasticizer (c1) advantageously chosen from benzoates or phthalates, such as diisononyl phthalate or diisobutyl phthalate.

Many plasticizers coming under these chemical families are available commercially. Mention may thus be made, as examples of plasticizers of benzoate type, of the following commercial products:
the neopentyl glycol dibenzoate available from Lanxess under the trade name Uniplex® 512;
the dipropylene glycol dibenzoate available from Eastman under the trade name Benzoflex™ 9-88 SG;
a mixture of diethylene glycol dibenzoate and dipropylene glycol dibenzoate available from Kalama Chemical under the trade name K-Flex® 850S;
a mixture of diethylene glycol dibenzoate, dipropylene glycol dibenzoate and triethylene glycol dibenzoate available from Eastman under the trade name Benzoflex™ 2088.

The oil (c2) is advantageously chosen from a vegetable oil, a naphthenic mineral oil, a paraffinic mineral oil or a mixture of naphthenic and paraffinic mineral oils, or also a saturated or unsaturated and linear or branched fatty alcohol comprising from 10 to 20 carbon atoms. Such oils (c2) are also available commercially. Mention may thus be made, as commercial product of naphthenic mineral oil type, of Nyflex® 222B from Nynas and, as commercial product of paraffinic mineral oil type, of Primol® 352 from Esso.

According to another embodiment of the composition according to the invention, the compound (c) is a tackifying resin (c3), with a number-average molar mass Mn of between 200 Da and 10 kDa.

The number-average molar masses shown are expressed in daltons (Da) and are determined by gel permeation chromatography, the column being calibrated with polystyrene standards.

The resin (c3) is advantageously chosen from:
(i) resins obtained by polymerization of terpene hydrocarbons and phenols, in the presence of a Friedel-Crafts catalyst;
(ii) resins obtained by a process comprising the polymerization of α-methylstyrene, it also being possible for said process to comprise a reaction with phenols;
(iii) rosins of natural origin or modified rosins, such as, for example, the rosin extracted from pine gum, wood rosin extracted from tree roots and their derivatives which are hydrogenated, dimerized, polymerized or esterified with monoalcohols or polyols, such as glycerol;
(iv) resins obtained by hydrogenation, polymerization or copolymerization (with an aromatic hydrocarbon) of mixtures of unsaturated aliphatic hydrocarbons having approximately 5, 9 or 10 carbon atoms resulting from petroleum fractions;
(v) terpene resins generally resulting from the polymerization of terpene hydrocarbons, such as, for example, monoterpene (or pinene), in the presence of Friedel-Crafts catalysts;
(vi) copolymers based on natural terpenes, for example styrene/terpene, α-methylstyrene/terpene and vinyltoluene/terpene; or else
(vii) acrylic resins having a viscosity at 100° C. of less than 100 Pa·s.

Such resins are commercially available and, among those of types (i), (ii) and (iii) defined above, mention may be made of the following products:
resins of type (i): Dertophene® H150, available from DRT, with a molar mass Mn equal to approximately 630 Da; Sylvarez® TP 95, available from Arizona Chemical, having a molar mass Mn of approximately 1200 Da;
resins of type (ii): Norsolene® W100, available from Cray Valley, which is obtained by polymerization of α-methylstyrene without action of phenols, with a number-average molar mass of 900 Da; Sylvarez® 510, which is also available from Arizona Chemical, with a molar mass Mn of approximately 1740 Da, the process for the production of which also comprises the addition of phenols;
resins of type (iii): Sylvalite® RE 100, which is an ester of rosin and pentaerythritol available from Arizona Chemical and with a molar mass Mn of approximately 1700 Da.

According to a preferred alternative form of the composition according to the invention, use is made, as resin (c3), of a resin chosen from those of type (i).

The composition according to the invention is homogeneous.

The term “homogeneous composition” is understood to mean the fact that the nature and the content by weight of the ingredients (a), (b) and (c) included in the composition are chosen so that the latter is homogeneous when it is heated to a temperature within the range extending from 50° C. to 130° C., the character of homogeneity been recognised by the presence of a single phase and by a uniform appearance of said composition. The compositions according to the invention which are homogeneous at the temperature of 100° C. are more particularly preferred.

The composition according to the invention has a viscosity, measured at 100° C., within the range extending from 20 to 200 000 mPa·s. Said viscosity is measured by means of a Brookfield viscometer according to Standard ASTM D 3236.

Preferably, said viscosity is within the range extending from 500 to 50 000 mPa·s, more preferably within the range extending from 1000 to 30 000 mPa·s and more preferably still within the range extending from 4000 to 20 000 mPa·s.

An amount of 0.1% to 2% of one or more stabilizers (or antioxidants) is additionally preferably included in the composition according to the invention. These compounds are introduced in order to protect the composition from degradation resulting from a reaction with oxygen which is liable to be formed by the action of heat, light or residual catalysts on certain starting materials, such as the tackifying resins. These compounds can include primary antioxidants, which trap free radicals and are generally substituted phenols, such as Irganox® 1010 from Ciba. The primary antioxidants can be used alone or in combination with other antioxidants, such as phosphites, for example Irgafos® 168, also from Ciba.

The cleaning composition according to the invention can be prepared by mixing its ingredients in the liquid state, if appropriate by heating in order to obtain them in the molten state or to render them more fluid, with the exclusion of air (preferably under an inert atmosphere). When the composition comprises a plasticizer (c1), the latter is introduced first into the mixing vessel. In all cases, the silane compound (b) is added after all the other ingredients. The stabilizers, if appropriate, are added after the introduction of the thermoplastic polymer (a) and before the introduction of the silane compound (b).

The present invention also relates to a process for cleaning the walls of items of industrial equipment which are coated with a layer of composition C comprising a polymer P having alkoxysilane groups, said process comprising the mixing of said composition C with a composition according to the invention.

Polymer P having alkoxysilane groups is understood to mean a polymer or oligomer with an average molecular weight within the range extending from 100 to 250 000 g/mol, preferably from 200 to 80 000 g/mol and more preferably still from 500 to 60 000 g/mol, said polymer P comprising at least two alkoxysilane groups.

The main chain of the polymer P is preferably chosen from a polyether chain, a polyurethane chain, a chain comprising polyurethane/polyether and polyurethane/polyester blocks.

The alkoxysilane groups can be grafted to the ends of the polymeric chain or to another part of the chain. Preferably, an alkoxysilane group is grafted to each of the two ends of the main chain of the polymer, such a group being described as “alkoxysilane terminal group” or also “alkoxysilane end group”. Alkoxysilane group is understood to mean a group of formula (VII):

—Si(R¹⁰)ₚ(OR¹¹)₃₋ₚ (VII)

in which:
R¹⁰ and R¹¹, which are identical or different, each represent a linear or branched alkyl radical of 1 to 4 carbon atoms, optionally interrupted by an oxygen atom, with in addition the possibility, when there are several R¹¹ radicals, for the latter, which are identical or different, to form a ring;
p is an integer equal to 0, 1 or 2.

Preferably, the composition C is a heat-crosslinkable adhesive composition and, more preferably still, a composition comprising, in addition to the polymer P having alkoxysilane groups (and in particular end groups), a tackifying resin and a crosslinking catalyst. Such compositions C are described in particular in the applications WO 2009/106699 and EP 2 336 208.

As a result of their highly viscous nature, residual amounts of these compositions are present and/or liable to be present on the walls of the items of industrial equipment with which they have come into contact, more particularly the internal walls, coating said walls with a more or less thick layer which is continuous or noncontinuous.

The amount of composition according to the invention to be employed in the process which is also a subject matter of the invention depends on the amount of composition C to be cleaned off. Said amount corresponds to a very large excess of the equivalent number of alkoxysilane groups of the silane compound (b) included in the amount of composition according to the invention, with respect to the equivalent number of alkoxysilane groups of the polymer P included in the amount of composition C. Preferably, this amount corresponds to an equivalent number of alkoxysilane groups of the compound (b)/number of alkoxysilane groups of the polymer P ratio at least equal to 2, preferably at least equal to 5.

According to a preferred alternative form of the process according to the invention, the items of industrial equipment, the walls of which can be cleaned by said process, are included in an industrial plant suited to the manufacture of self-adhesive supports by coating with said composition C, also denoted by the term of “industrial coating line”. Such items of equipment are in particular:
the storage tank or tanks (such as, for example, a drum) containing the composition C to be coated, for the purpose of its prior fluidization by heating:
one or more heating plates suited to the heating of the adhesive composition C present in said tank or tanks, more particularly the lower part of said plate or plates which is in contact with said adhesive composition C;
the coating head (for example, a coating nozzle);
the feed line or lines connecting the heating plate or plates to said head.

The presence in the industrial coating line of several storage tanks and thus of several heating plates makes it possible to obtain an advantageous improvement in the productivity of the plant.

Other items of industrial equipment can also be cited, as components of a coating line, and on the walls of which residual amounts of composition C are present and/or liable to be present:
the pumps,
the filters,
holding tanks containing the heated composition C in the viscous liquid form and under an inert atmosphere,
a static mixer (with in particular its mixing elements) used, for example, as constituent of an induction heating device, or finally
a dynamic mixer, for example of twin-screw type.

An industrial coating line generally operates under continuous conditions. The walls of the corresponding items of industrial equipment which are coated with a layer of composition C are thus very particularly those of the dead regions, in other words of the regions of the line in contact with which the rate of flow of the competition C, during the operation of the line under continuous conditions, is weak or nonexistent. Such walls are, for example, the surface of the heating plate provided or not provided with fins, the internal walls of the flexible heating hose made of reinforced PTFE mentioned above, the internal walls of the components made of stainless steel which connect said flexible to the heating plate and to the coating nozzle and, finally, some walls located inside the coating nozzle. The presence of residual amounts of composition C on the walls of dead regions can be observed on the items of industrial equipment included in a coating line having operated under continuous conditions, after it has been shut down and dismantled.

According to an even more preferred alternative embodiment of the process according to the invention, the industrial coating line is fed in semicontinuous mode, using as storage tank the drum (for example of 200 l) in which the composition C is packaged in the form generally of a solid or of a liquid which is extremely viscous at ambient temperature. The composition C present in such a drum is heated by bringing into contact with a heating plate, preferably at a temperature of 80° C. to 130° C., so as to exhibit a viscosity sufficient for its in-line circulation.

In order to produce, in the context of a manufacturing campaign, the desired amount of a specific grade of self-adhesive support, the manager of a coating line operating under continuous conditions according to said alternative form carries out, when this is necessary, the replacement of an empty drum by a full drum of composition C. Such a replacement does not require the shutdown of the industrial plant.

On the other hand, when the manager of the industrial coating line has completed manufacturing the desired amount of self-adhesive support by means of a certain grade of heat-crosslinkable adhesive composition, or else when he desires to carry out the coating with another grade of adhesive composition, it is necessary to shut down the plant and then, possibly, to dismantle it for the purpose of cleaning it.

In accordance with said preferred alternative form, the cleaning process which is a subject matter of the invention then comprises, after the operation under continuous conditions of the industrial coating line and before it is shut down, a stage of feeding said line with a drum containing the cleaning composition according to the invention, as replacement for the drum containing the composition C.

The cleaning composition is thus fed, under continuous conditions, into the industrial coating line for the time necessary in order to fill it, to remove the residues of composition C which adhere to the walls, in particular of the dead regions, and to ensure the discharge of said residues out of the line, avoiding the risk of formation of crosslinked residual products which adhere very strongly to the walls.

The industrial line is then filled with the cleaning composition according to the invention, the viscosity of which is advantageously stable over time and which does not exhibit a risk of formation of deposits liable to block or foul the plant. According to an alternative embodiment of the process according to the invention, the industrial line remains filled with the cleaning composition according to the invention throughout the period of time during which it is shut down.

During the start-up of a campaign for the manufacture of another grade of heat-crosslinkable adhesive composition C, it will be sufficient to feed the industrial coating line with said composition and to thus purge, from said line, the cleaning composition which it contains, by virtue of the advantageous properties of viscosity and of flow of the latter.

The following examples are given purely by way of illustration of the invention and should not be interpreted so as to limit the scope thereof.

### EXAMPLE 1: CLEANING COMPOSITION BASED ON EVA

1. Preparation:

The composition appearing in table 1 is prepared by introducing first of all the plasticizer (c1) into an electrically heated glass reactor equipped with a mechanical stirrer and connected to a vacuum pump. The plasticizer is kept stirred and under vacuum until the temperature reaches 145° C.

The EVA, in the form of granules, is then charged, slowly and with stirring, as thermoplastic polymer (a). Stirring is maintained and the vacuum is re-established until a homogeneous liquid mixture is obtained, i.e. for approximately 60 minutes.

The liquid mixture is then cooled until a temperature of 85° C. is reached and then the reactor is brought back to atmospheric pressure by injection of dry nitrogen (containing less than 3 ppm of water). The monofunctional silane compound (b) shown in table 1 is subsequently charged under the same nitrogen atmosphere. Once this charging is complete, the vacuum and the stirring are re-established in the reactor so as to homogenize the mixture, i.e. for approximately 15 minutes.

The viscosity of the composition obtained is measured at 100° C. by means of a Brookfield viscometer provided with an A27 needle rotating at a speed of 10 rev/minute and according to the standard ASTM D 3236. The value obtained is shown in table 1.

The composition obtained is finally packaged in a cylindrical aluminum cartridge, with a capacity of 350 ml, which is hermetically closed with the exclusion of air by crimping of the disk-shaped bottom.

2. Test of Usefulness for Cleaning:

2.1. Description of the Test and Result:

The test used to quantify the usefulness of the composition prepared in 1. for the cleaning of the walls of a reactor which are coated with a heat-crosslinkable adhesive composition comprising a polymer having end groups of alkoxysilane type is described below.

Prior to this test, the amount of a heat-crosslinkable adhesive composition of reference R necessary for the packaging thereof in a cartridge (identical to that described above) is prepared, which composition comprises:
53.7% by weight of a polyurethane obtained from a polypropylene glycol (or poly(isopropoxy)diol) and comprising two trimethoxysilane terminal groups,
44.7% of a tackifying resin obtained by polymerization of terpene hydrocarbons and phenols, in the presence of a Friedel-Crafts catalyst, and
1.1% of a crosslinking catalyst.

The composition R is that described in example 2 of the application WO 2009/106699 and reference is made to this document for the details relating to the nature of its ingredients and the methods for its preparation.

The two hermetically closed aluminum cartridges, respectively containing the composition of example 1 to be tested and the reference composition R, are first of all put on to preheat at a temperature of 100° C. for 2 hours.

A 500-ml glass reactor which is electrically heated and which is equipped with a mechanical stirrer adjustable in height, the temperature of which is maintained at 100° C. throughout the duration of the test, is used. This reactor is placed under a hood in a controlled atmosphere: temperature of 23° C. and relative humidity of 50%.

50 grams of the reference composition R are introduced into the reactor. Immediately after this introduction, the reactor is closed and circulation of dry nitrogen (containing less than 3 ppm of water) is put in place for approximately 3 minutes. The mechanical stirrer is positioned in the reactor at a height such that it is not in contact with the composition R.

The circulation of nitrogen is halted, the reactor is opened and then 150 g of the composition of example 1 are introduced over a time of between 5 and 10 minutes. The reactor is then flushed with dry nitrogen (containing less than 3 ppm of water) for 5 seconds and the reactor is closed again. The mechanical stirrer is positioned at a height such that it is in contact with the composition resulting from this last introduction. Stirring is maintained at 30 revolutions/minute for 1 hour, the composition being in contact with the mixture of atmospheric air and nitrogen present in the reactor.

At the end of one hour, the presence in the reactor of a homogeneous composition in the form of a viscous liquid is observed. A sample of 12.5 g of said composition is withdrawn for measurement of the viscosity at 100° C. by means of a Brookfield viscometer equipped with an A27 needle rotating at a speed of 10 rev/minute. The value is recorded 20 minutes after introduction of the composition into the viscometer and the value obtained is shown in table 1.

After the withdrawal of the 12.5 grams of composition intended for the measurement of the viscosity, the reactor is inclined so as to cause its contents to flow, by gravity, into a container in order to be discarded.

After cooling the reactor to ambient temperature, the product remaining on the walls of the reactor is subsequently removed manually by simple wiping by means of a rag made of nonwoven material, this wiping with a clean rag being repeated if necessary several times until a residue adhering to the wall of the reactor is obtained which can no longer be removed by said wiping. Washing with the solvent of methyl ethyl ketone type is then necessary in order to remove said residue and to obtain a clean reactor.

The usefulness of the composition prepared in 1) for the cleaning of walls which are coated with the composition R is evaluated by the amount of product remaining in the reactor which is removed after wiping the reactor with said rag and before washing off the adherent residual product with the solvent.

This amount is estimated according to the following grading:

+ means that an amount of approximately 50% of the remaining product has been removed

++ means that an amount of approximately 75% of the residual product has been removed

+++ means that an amount of approximately 95% of the residual product has been removed

The grading obtained is shown in table 1.

The results obtained show that the composition prepared in 1. is suitable for the cleaning of the walls of the reactor which are coated with the reference heat-crosslinkable adhesive composition R.

2.2. Control Test:

The procedure described in 2.1. is repeated, except that, after the introduction into the reactor of the reference composition R and flushing with nitrogen, the reactor is opened for approximately 7 minutes without introducing cleaning composition, so that, for 1 hour, the composition R remains alone in contact with the mixture of atmospheric air and nitrogen present in the reactor, without any stirring.

At the end of one hour, the presence in the reactor of a solid layer, which represents approximately 50% by volume of the composition R (also described as “skin”) and which adheres very strongly to the walls and to the stirrer, is observed. Said layer corresponds to the crosslinking of the polyurethane having an alkoxysilane group included in the composition R. The cleaning in this case can only be carried out after dipping the glass reactor and the stirrer in solvent of methyl ethyl ketone type for at least 24 hours.

### EXAMPLE 2 (COMPARATIVE)

An EVA-based composition identical to that of example 1, with the exception of the content of monofunctional silane (b) of 10%, which is reduced to 0, and of the content of plasticizer (c), which is brought from 60% to 70%, is prepared.

For this, the stages shown in the procedure of point 1. of example 1 are repeated, the stage of charging the monofunctional silane (b) simply being omitted and viscosity being measured after obtaining the homogeneous liquid mixture of the plasticizer (c1) and of the EVA (a).

The viscosity at 100° C. of the composition obtained is shown in table 1.

The test of usefulness for cleaning of this composition is carried out by repeating the procedure shown in 2. for example 1.

After introducing 150 g of said cleaning composition into the reactor and stirring the composition resulting from the mixing thereof with the composition R, there is observed, in less than one hour, the formation of a product in the form of an extremely viscous gel, the viscosity of which cannot be measured by means of the Brookfield viscometer used in example 1 and which adheres very strongly to the wall of the reactor and to the stirrer. The presence of this product is shown in table 1 by the comment “gel”.

Once the contents of the reactor have been poured into a container in order to be discarded, it is not possible to remove, by wiping with the rag, the product which remains in the reactor in the form of said gel adhering to its walls and to the stirrer. Only washing with the solvent of methyl ethyl ketone type makes it possible to remove said residue and to obtain a clean reactor. This is indicated by the grading “−” in table 1.

This composition is not suitable for the cleaning of the walls of the reactor brought into contact with the reference composition R.

### EXAMPLES 3-8

Example 1 is repeated for the compositions having the natures and the contents of ingredients shown in table 1, which also reveals the viscosities at 100° C. of the compositions prepared and also the results obtained for the test of usefulness for cleaning of said compositions.

### EXAMPLE 9: CLEANING COMPOSITION BASED ON A POLYURETHANE HAVING HYDROXYL END GROUPS OBTAINED FROM POLYCAPROLACTONE

The procedure shown for example 1 in point 1. is repeated, so as to prepare a cleaning composition consisting of:
25% by weight of Pearlbond™ 100, as thermoplastic polymer (a), introduced in the form of granules,
5% by weight of Geniosil® XL 63 as monofunctional silane compound (b); and
70% by weight of Uniplex® 512 as plasticizer (c1).

The Brookfield viscosity measured at 100° C. on said composition thus prepared is 2500 mPa·s.

The test of usefulness for cleaning is also carried out. The viscosity at 100° C., measured on the homogeneous composition obtained after mixing for 1 hour, is 3000 mPa·s. The grade associated with the test is: ++.

TABLE 1
EVA-based compositions

| | | Content as % by weight | | | | | | | |
|---|---|---|---|---|---|---|---|---|---|
| | | | Ex. 2 | | | | | | |
| Ingredients | | Ex. 1 | (comparative) | Ex. 3 | Ex. 4 | Ex. 5 | Ex. 6 | Ex. 7 | Ex. 8 |
| (a) | Evathane ® 40-55 | 30 | 30 | 30 | 30 | 30 | 30 | 30 | 30 |
| (b) | Silquest ® Y 15866 | | | | | | 5 | | |
| | Silquest ® A 174 | | | | | | | 5 | |
| | Geniosil ® XL 63 | 10 | 0 | 5 | 1 | | | | 5 |
| | Geniosil ® XL 33 | | | | | 5 | | | |
| (c1) | Uniplex ® 512 | | | | | | | | |
| | Benzoflex ™ 9-88 | 60 | 70 | 65 | 69 | 65 | | | |
| | K-Flex ® 850S | | | | | | 65 | 65 | |
| | Benzoflex ™ 2088 | | | | | | | | 65 |

| | | | | | | | | |
|---|---|---|---|---|---|---|---|---|
| Viscosity at 100° C. (mPa · s) | 4500 | 9801 | 7000 | 9801 | 6500 | 8500 | 7100 | 8900 |
| Test of usefulness for cleaning: | | | | | | | | |
| Viscosity at 100° C. (mPa · s) | 4300 | Gel | 6670 | 25 000 | 7100 | 9400 | 7850 | 9900 |
| grade | + | − | + | + | +++ | + | + | +++ |

### EXAMPLE 10 (COMPARATIVE)

Example 9 is repeated so as to prepare a composition identical to that of said example, with the exception of the content of monofunctional silane (b) of 5%, which is reduced to 0, and of the content of plasticizer (c1), which is brought from 70% to 75%. The preparation is carried out in accordance with the protocol of example 2.

The Brookfield viscosity measured at 100° C. on said composition thus prepared is 4200 mPa·s.

Carrying out the test of usefulness for cleaning leads to the same result as example 2, with formation of a gel and impossibility of removing, by wiping with the rag, the product remaining in the reactor.

### EXAMPLE A (REFERENCE): PREPARATION OF A THERMOPLASTIC POLYURETHANE HAVING HYDROXYL END GROUPS

The following compounds are used for the purpose of this preparation:
isophorone diisocyanate (IPDI), available from Evonik Industries under the trade name Vestanat® IPDI and exhibiting a content of —NCO group of 37.6% by weight;
a linear polyether polyol Acclaim® 18200 N, available from Bayer and exhibiting a hydroxyl number of 6.0 mg KOH/g; and
a catalyst of zinc-based organometallic type, available from OMG Borchers GmbH under the name Borchi® KAT 0244.

The polyether polyol is introduced into a glass reactor equipped with a mechanical stirrer and connected to a vacuum pump, and heating is carried out under vacuum so as to reach a temperature of 85° C. until a residual water content of said polyether of less than 150 ppm is obtained, said content being measured by the Karl Fischer method. These conditions are maintained for an additional 30 minutes and then the system is brought back to atmospheric pressure under circulation of dry nitrogen containing less than 3 ppm of water.

The diisocyanate is then slowly charged and the catalyst is introduced 20 minutes after the end of the addition of the diisocyanate. The reaction medium is maintained at 85° C., under stirring and flushing with nitrogen, for approximately 90 minutes, until the complete disappearance of the NCO functional groups measured by infrared spectroscopy.

The respective amounts of polyether polyol and diisocyanate introduced correspond to the contents by weight shown in table 2 and to a ratio: number of —NCO equivalents/number of —OH equivalents equal to 0.5.

The polyurethane obtained exists in the form of a very viscous liquid which is packaged in an aluminum cartridge.

TABLE 2
(reference): polyurethanes obtained from polyether polyols

| | | Content by weight | |
|---|---|---|---|
| | | of reactants per 100 | |
| | | g of polyurethane formed | |
| | | Ex. A | Ex. B |
| Reactants | | (reference) | (reference) |
| Isocyanate | Vestanat ® IPDI | 0.57 | — |
| | Isonate ® M 125 | — | 5.08 |
| Polyether polyol | Acclaim ® 18200 N | 99.33 | — |
| | Voranol ® EP 1900 | — | 94.82 |
| Catalyst | Borchi ® KAT 0244 | 0.10 | 0.10 |

### EXAMPLES 11 and 12: CLEANING COMPOSITION BASED ON THE POLYURETHANE HAVING HYDROXYL END GROUPS OF EXAMPLE A

The procedure shown for example 1 in point 1. is repeated, so as to prepare a cleaning composition having the natures and the contents of ingredients shown in table 3. For this, after preheating to approximately 60° C. the aluminum cartridge containing the polyurethane of example A, the polyurethane is charged to the reactor as thermoplastic polymer (a).

The results obtained are shown in table 3.

### EXAMPLE 13: CLEANING COMPOSITION BASED ON THE POLYURETHANE HAVING HYDROXYL END GROUPS OF EXAMPLE A

The procedure shown for examples 11 and 12 is repeated, the plasticizer (c1) being replaced with the tackifying resin Dertophene® H150 (c3), so to prepare a cleaning composition having the content of ingredients shown in table 3.

The results obtained are shown in table 3.

TABLE 3
compositions based on the polyurethane of example A

| | | Content as % by weight | | | |
|---|---|---|---|---|---|
| | | | | | Ex. 14 |
| Ingredients | | Ex. 11 | Ex. 12 | Ex. 13 | (comparative) |
| (a) | Polyurethane Example A | 65 | 60 | 39 | 40 |
| (b) | Geniosil ® XL 63 | 5 | 5 | 6 | 0 |
| (c) | Uniplex ® 512 | | 35 | | |
| | Benzoflex ™ 2088 | 30 | | | |
| (d) | Dertophene ® H150 | | | 55 | 60 |

| | | | | |
|---|---|---|---|---|
| Viscosity at 100° C. (mPa · s) | 19 950 | 11 200 | 19 000 | 26 000 |
| Test of usefulness for cleaning: | | | | |
| Viscosity at 100° C. (mPa · s) | 18 000 | 12 000 | 19 500 | Gel |
| grade | + | +++ | ++ | − |

### EXAMPLE 14 (COMPARATIVE): COMPOSITION BASED ON THE POLYURETHANE HAVING HYDROXYL END GROUPS OF EXAMPLE A

Example 9 is repeated while omitting the monofunctional silane (b) and with the contents of ingredients shown in table 3.

The results obtained are shown in table 3.

### EXAMPLE B (REFERENCE): PREPARATION OF A THERMOPLASTIC POLYURETHANE HAVING HYDROXYL END GROUPS

The following compounds are used for the purpose of this preparation:
4,4′-diphenylmethane diisocyanate (4,4′-MDI), available from Dow Chemical under the trade name Isonate™ M 125 and exhibiting a content of —NCO group of 33.6% by weight;
a linear polyether polyol Voranol® EP 1900, available from Bayer and exhibiting a hydroxyl number of 28.5 mg KOH/g; and
the same catalyst as that of example A.

The polyurethane is prepared by repeating the procedure of example A.

The respective amounts of polyether polyol and of isocyanate introduced correspond to the contents by weight shown in table 2 and to a ratio: number of —NCO equivalents/number of —OH equivalents equal to 0.8.

### EXAMPLES 15-17: CLEANING COMPOSITION BASED ON THE POLYURETHANE HAVING HYDROXYL END GROUPS OF EXAMPLE B

The monofunctional silane (b) is also added, under the conditions described in example 1, to the glass reactor in which the polyurethane of example B was prepared, so as to obtain the cleaning composition having the natures and the contents of ingredients shown in table 4.

The results obtained are shown in table 4.

### EXAMPLE 18 (COMPARATIVE): Composition Based on the Polyurethane Having Hydroxyl End Groups of Example B

Examples 15-17 are repeated without also adding monofunctional silane (b).

The results obtained are shown in table 4.

TABLE 4
compositions based on the polyurethane of example B

| | | Content as % by weight | | | |
|---|---|---|---|---|---|
| | | | | | Ex. 18 |
| Ingredients | | Ex. 15 | Ex. 16 | Ex. 17 | (comparative) |
| (a) | Polyurethane Example B | 95 | 95 | 97.5 | 100 |
| (b) | Geniosil ® XL 33 | 5 | | | 0 |
| | Geniosil ® XL 63 | | 5 | 2.5 | 0 |

| | | | | |
|---|---|---|---|---|
| Viscosity at 100° C. (mPa · s) | 8800 | 8800 | 9800 | 8600 |
| Test of usefulness for cleaning: | | | | |
| Viscosity at 100° C. (mPa · s) | 10 300 | 10 000 | 17 000 | Gel |
| grade | +++ | + | +++ | − |

1. A cleaning composition comprising, on the basis of the total weight of said composition:
from 5% to 99% by weight of a thermoplastic polymer which does not react with moisture (a) chosen from:
polyurethanes having hydroxyl or alkyl end groups;
polyamides;
polyesters;
ethylene-based copolymers;
amorphous poly(α-olefin)s, polybutadiene, polyisoprene;
block polyolefins;
styrene block copolymers;
acrylic copolymers;
polymeric alcohols obtained by oxidation of α-olefins;
from 1% to 15% by weight of a silane compound (b) comprising a single alkoxysilane group;
from 0% to 94% by weight of a compound (c) chosen from a plasticizer (c1), an oil (c2) or a tackifying resin (c3);
said composition being homogeneous and having a Brookfield viscosity, measured at 100° C. according to the standard ASTM D 3236, within the range extending from 20 to 200 000 mPa·s.

2. The composition as claimed in claim 1, characterized in that the thermoplastic polymer (a) is chosen from polyurethanes, polyamides, polyesters, ethylene-based copolymers, acrylic copolymers and polymeric alcohols obtained by oxidation of α-olefins.

3. The composition as claimed in claim 1, characterized in that the thermoplastic polymer (a) is chosen from copolymers based on ethylene and vinyl acetate and polyurethanes having hydroxyl end groups.

4. The composition as claimed in claim 1, characterized in that the alkoxysilane group of the silane compound (b) is of formula (I):
—Si(R¹)ₙ(OR²)₃₋ₙ (I)
in which:
R¹ and R², which are identical or different, each represent a linear or branched alkyl radical of 1 to 4 carbon atoms, optionally interrupted by an oxygen atom, with in addition the possibility, when there are several R² radicals, for the latter, which are identical or different, to form a ring;
n is an integer equal to 0, 1 or 2.

5. The composition as claimed in claim 1, characterized in that the silane compound (b) is chosen from the compounds of following formulae:
R⁴—SiR¹ₙ(OR²)₃₋ₙ (II)
R⁵—C(O)—O—R³—SiR¹ₙ(OR²)₃₋ₙ (III)
R⁶—C(O)—N(R⁸)—R³—SiR¹ₙ(OR²)₃₋ₙ (IV)
R⁷—O—C(O)—NH—R³—SiR¹ₙ(OR²)₃₋ₙ (V)
(R⁷)(R⁹)N—C(O)—NH—R³—SiR¹ₙ(OR²)₃₋ₙ (VI)
in which:
R¹, R² and n are identical or different, each represent a linear or branched alkyl radical of 1 to 4 carbon atoms, optionally interrupted by an oxygen atom, with in addition the possibility, when there are several R² radicals, for the latter, which are identical or different, to form a ring;
n is an integer equal to 0, 1 or 2;
R³ represents a divalent alkylene radical, which is preferably linear, comprising from 1 to 4 carbon atoms;
R⁴ represents a linear or branched alkyl or alkenyl radical comprising from 2 to 60 carbon atoms;
R⁵, R⁶ and R⁷ represent, each taken independently, a linear or branched alkyl or alkenyl, aromatic or alicyclic radical comprising from 1 to 60 carbon atoms;
R⁸ represents a linear or branched alkyl or alkenyl, aromatic or alicyclic radical comprising from 1 to 6 carbon atoms;
R⁹ represents a hydrogen atom, a linear or branched alkyl or alkenyl radical, an aromatic radical or an alicyclic radical comprising from 1 to 60 carbon atoms.

6. The composition as claimed in claim 1, characterized in that the compound (c) is a plasticizer (c1) chosen from benzoates or phthalates.

7. The composition as claimed in claim 1, characterized in that the compound (c) is a tackifying resin (c3), with a number-average molar mass Mn of between 200 Da and 10 kDa.

8. The composition as claimed in claim 7, characterized in that the tackifying resin (c3) is chosen from:
(i) resins obtained by polymerization of terpene hydrocarbons and phenols, in the presence of a Friedel-Crafts catalyst;
(ii) resins obtained by a process comprising the polymerization of α-methylstyrene, it also being possible for said process to comprise a reaction with phenols;
(iii) rosins of natural origin or modified rosins, such as, for example, the rosin extracted from pine gum, wood rosin extracted from tree roots and their derivatives which are hydrogenated, dimerized, polymerized or esterified with monoalcohols or polyols, such as glycerol;
(iv) resins obtained by hydrogenation, polymerization or copolymerization (with an aromatic hydrocarbon) of mixtures of unsaturated aliphatic hydrocarbons having approximately 5, 9 or 10 carbon atoms resulting from petroleum fractions;
(v) terpene resins generally resulting from the polymerization of terpene hydrocarbons, such as, for example, monoterpene (or pinene), in the presence of Friedel-Crafts catalysts;
(vi) copolymers based on natural terpenes, for example styrene/terpene, α-methylstyrene/terpene and vinyltoluene/terpene; or else
(vii) acrylic resins having a viscosity at 100° C. of less than 100 Pa·s.

9. The composition as claimed in claim 8, characterized in that use is made, as resin (c3), of a resin chosen from those of type (i).

10. The composition as claimed in claim 1, characterized in that its viscosity, measured at 100° C., is within the range extending from 500 to 50 000 mPa·s, preferably within the range extending from 4000 to 20 000 mPa·s.

11. A process for cleaning the walls of items of industrial equipment which are coated with a layer of composition C comprising a polymer P having alkoxysilane groups, said process comprising the mixing of said composition C with a cleaning composition as defined in claim 1.

12. The process as claimed in claim 11, characterized in that the main chain of the polymer P is chosen from a polyether chain, a polyurethane chain, a chain comprising polyurethane/polyether and polyurethane/polyester blocks, and in that an alkoxysilane group is grafted to each of the two ends of said main chain.

13. The process as claimed in claim 11, characterized in that the composition C comprises, in addition to the polymer P, a tackifying resin and a crosslinking catalyst.

14. The process as claimed in claim 11, characterized in that the items of industrial equipment are included in an industrial line for coating with the composition C.

15. The process as claimed in claim 14, characterized in that the industrial coating line is fed in semicontinuous mode using, as storage tank, the drum for packaging the composition C and in that said process comprises, after the operation under continuous conditions of the line and before it is shut down, a stage of feeding the latter with a drum containing the cleaning composition, as replacement for the drum containing the composition C.
